(19) United States
(12) Patent Application Publication
(10) Pub. No.: US 2011/0131886 A1
(43) Pub. Date: Jun. 9, 2011

(54) DISHWASHER WITH DAMPENING MEANS FOR DAMPENING THE CLOSING OF THE DOOR

(76) Inventor: Gerhard Durr, Oberasbach (DE)

(21) Appl. No.: 12/990,413

(22) PCT Filed: May 5, 2009
(86) PCT No.: PCT/EP2009/003201

§ 371 Date: Jan. 18, 2011

(30) Foreign Application Priority Data
May 8, 2008 (EP) 08008661.4

(51) Int. Cl. A47L 15/42; E05F 3/04; E05F 3/14; E05F 3/00

(52) U.S. Cl. 49/386; 16/51; 16/49

(57) ABSTRACT

In a dishwasher of the built-in type comprising a door (12) which is tillable about a generally horizontal axis (A), the door comprising means for fixing a decor panel (14), said dishwasher further comprising means (24) for biasing the door towards the closed position and dampening means (26) for dampening the closing of the door, the dampening means is or can be adapted for dampening the closing of the door in the undecorated state of the door.

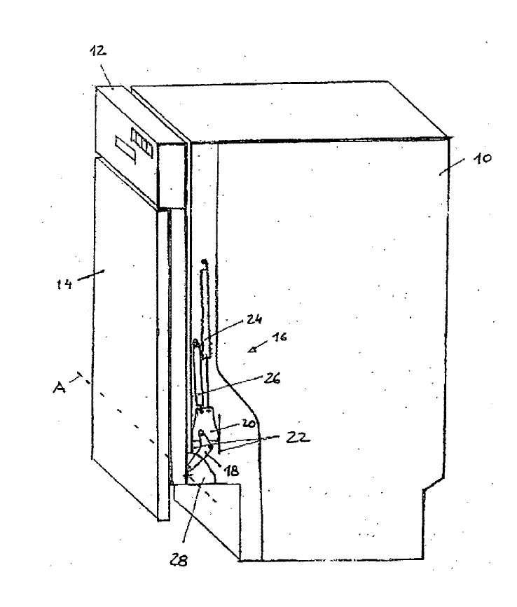

The present invention relates to a dishwasher of the built-in type comprising a door which is tiltable about a generally horizontal axis, the door comprising means for fixing a decor panel and said dishwasher further comprising means for biasing the door towards the closed position and dampening means for dampening the closing of the door.

In household appliances, which have a front door that is tiltable about a horizontal axis, such as dishwashers or ovens, and wherein the door may have a considerable weight, particularly when the household appliance is of the built-in type, in which case an additional decor panel is mounted to the door, it has been suggested to provide for means for balancing and/or dampening the movement of the door.

In EP 0 919 776 B1, EP 1 183 988 A2 and EP 1 302 150 A1 there are disclosed counterbalanced hinge devices for dishwashers, wherein for counterbalancing the additional weight of a decor panel which is fixed to the dishwasher door and the weight of which can vary substantially there is provided for a friction arrangement which exerts increasing frictional forces during opening the dishwasher door so as to exert a balancing force on the door so as to at least partially counteract gravity forces acting on the door.

EP 0 392 588 A1 discloses a dishwasher comprising a door which is tiltable about a generally horizontal axis and a door balancing system for balancing the door in a plurality of intermediate positions between the opened and the closed positions of the door. The door balancing system comprises an extension spring, one end of which is attached to the dishwasher body and the other end of which is coupled to a friction band which extends along friction surfaces provided in the body of the dishwasher and which is connected to the dishwasher door, such that when the door is opened the friction band tightens the spring. In this manner there is provided for a balancing of the door and at the same time for dampening of the opening movement of the door, wherein due to the increasing spring force of the door during opening also the friction force caused by the friction band and hence the dampening action thereof increase.

DE 10 2005 044 343 A1 discloses a household appliance, particularly an oven, comprising a door which is tiltable about a horizontal axis, means for actively closing the door and dampening means for dampening the closing of the door, the dampening means comprising an energy dissipating element which may be designed as a pneumatic dampening element.

Similarly, DE 10 2005 045 365 A1 discloses a household appliance, particularly an oven, comprising a door which is tiltable about an horizontal axis, means for actively closing the door and dampening means for dampening the closing of the door, the dampening means comprising an energy dissipating element which may be designed as a hydraulic dampening element.

DE 103 60 385 A1 discloses a door hinge for a door of a domestic appliance, such as an oven, freezer, refrigerator, dish washer or washing machine, wherein the door hinge has two sections which are pivotable in relation to one another within a pivot angle range between a minimum and a maximum angle. The hinge has an additional functional unit which is connected to both hinge sections and which can occupy at least two functioning positions. In addition, a dampening element, such as a pneumatic dampening element, can be coupled to the functional unit so as to dampen the closing of the door.

Finally, EP 0 478 523 A1 discloses a dishwasher of the built-in type comprising a door which is tiltable about a generally horizontal axis and which comprises means for fixing a decor panel. In order to provide for a smooth opening of the door also for different weights of the door in the decorated state, the dishwasher comprises dampening means, such as a gas spring or an oil or friction damper, for dampening the opening of the door shortly before the door reaches its fully opened position.

From the above it is to be seen that while in the prior art the problem of having in one and the same household appliance different door weights depending on the type of decor panel that is attached to a built-in type household appliance was recognized as such, the prior art discusses this problem solely in terms of seeking solutions to compensate the additional weight of the door when opening the door. What the prior art, however, failed to recognize, is that in household appliances and in particular dishwashers of the built-in type, adjusting a door biasing or balancing system which biases the door towards the closed position based on the weight of the door in the decorated state, i.e. taking into account the normal end use situation to be expected, this inherently creates a security risk at the retailer of such dishwasher. In particular, since at the retail stage such household appliances usually are on exhibition in their undecorated state, i.e. in a condition when the door is much lighter than in the decorated state, the means for biasing the door towards the closed position due to its adjustment for the higher weight of the door in its decorated state creates door closing forces which by far exceed the force that is required for smooth closing of the door. This inadvertently creates a risk of injury of any salesperson or customer inspecting the dishwasher and not expecting the high velocity of the closing door which is caused by the door balancing means—and if present also the dampening means—being adjusted to the higher door weight of the door in its decorated state.

In view of the above, it is an object of the present invention to provide for a dishwasher of the built-in type, which overcomes the above problem and which thus provides for higher security during all stages of use of the dishwasher, i.e. not only during end use of the dishwasher, but also during the retail stage.

In a dishwasher of the built-in type comprising a door which is tiltable about a generally horizontal axis, the door comprising means for fixing a decor panel and said dishwasher further comprising means for biasing the door towards the closed position and dampening means for dampening the closing of the door, in accordance with the present invention the above problem is solved in that said dampening means is or can be adapted for dampening the closing of the door in the undecorated state of the door. In the present application the term “undecorated state of the door” is to be understood as before mounting a decor panel to the door. With the dampening means being adapted, be it already when leaving the factory or when positioning the dishwasher at the retailer, for dampening the closing of the door in the undecorated state of the door, the movement of the door at least at the end of the closing movement, i.e. at least shortly before the door reaches the closed position, is sufficiently decelerated, so as to prevent damages of the dishwasher and to substantially decrease the risk of injury caused by a person reaching into the gap between the dishwasher body and the closing door during all phases of use of the dishwasher. In particular, since the dampening means is adjusted to dampen the closing of the door in the undecorated state of the door, i.e. in a state where due to the lower weight of the door higher closing forces are applied to the door, it is to be understood that such dampening function, all the more, will be provided in the decorated state of the door, when due to the higher weight of the door that has to be lifted when closing the door, the door is closed with a lower velocity.

Thus, the present concept takes into consideration that in a dishwasher of the built-in type, during installation, be it at the retailer or at the end user, usually no adaptation of any parts of the dishwasher is performed, by which the differences in the movement of the door in its undecorated state versus its decorated state are compensated. For this reason, in accordance with the present invention different adjustments are selected for the dampening means on the one hand, and for any other parts that influence the movement of the door on the other hand, such as means for biasing the door towards the closed position and/or a door balancing system for balancing the door in a plurality of intermediate positions between the opened and the closed positions. In particular, whereas the latter will be as heretofore adjusted to the weight of the door in the decorated state, the dampening means is adapted for dampening the closing of the door in the undecorated state of the door.

Preferred embodiments of the invention are defined in the dependent claims.

In particular, the dampening means may comprise a hydraulic or pneumatic dampening element, particularly a pneumatic spring or a shock absorber. In this manner, the dampening function can be provided for by using constructional elements, which are already available on the market in a wide variety and which hence need not be redesigned or specifically manufactured. Thus, the dishwasher can be manufactured in a cost-effective manner.

Preferably, the means for biasing the door towards the closed position, such as a spring arrangement that is coupled to a hinge mechanism of the door, is adjusted based on the weight of the door in the decorated state, so that for installation of the dishwasher at the end user it is not required to interfere with such biasing means.

In preferred embodiments the dishwasher further comprises a door-balancing system for balancing the door in a plurality of intermediate positions between the opened and the closed positions of the door, wherein the dampening means is coupled to the door balancing system. The door-balancing system may comprise, for example, a friction arrangement for exerting a predetermined friction in dependency of the position of the door.

While in the present application the term “door-balancing system” is used to describe a system which assists balancing the door in a plurality of intermediate positions between the opened and the closed positions of the door, i.e. a system which counteracts gravity forces acting on the door particularly in the range of movement of the door towards its fully opened position, the said door-balancing system can also be integrated with the means for biasing the door towards the closed position, which also counteracts gravity forces acting on the door.

Most preferably the dishwasher comprises a door-balancing system which is integrated both with the means for biasing the door towards the closed position and with the dampening means. Thus, while the dampening means also could be designed as a stand-alone unit, which operates independently from any other parts of the dishwasher, it is preferred to couple the dampening means to the door-balancing system and the biasing means. This on the one hand allows to integrate the dampening system with the door-balancing system and the biasing means, so that the present invention can be readily implemented in dishwashers, which already are adapted for integration of a door balancing system and/or a biasing means with the least possible amount of redesign of the machine, and on the other hand provides for a high degree of adaptation of the operation of the dampening means to the operation of the door-balancing system and the biasing means.

Alternatively, the dampening means also could be coupled to any other parts of the dishwasher which are associated with the movement of the door, for example closing means for assisting closing of the door, such as spring arrangements or the like, or active door closing means, which, for example by the use of electro-motoric force actively close the door at least in the last part of its closing motion.

Furthermore, the dampening means may comprise a first dampening element, which is or can be adapted for dampening the closing of the door in the decorated state of the door, i.e. when a decor panel is attached to a door, as well as a second dampening element, which is or can be adapted to compensate any higher door-closing forces, that are caused by the lower weight of the door in its undecorated state. In such embodiments means may be provided for deactivating the said second dampening element after a decor panel was mounted to the door, so as to adjust the dampening means to its end use, i.e. to the weight of the door in its decorated state after final installation of the dishwasher.

A preferred embodiment of the invention is described in further detail by reference to the single drawing which shows a schematic perspective view, partially broken away, of a dishwasher made in accordance with the present invention.

The dishwasher shown in the FIGURE comprises a dishwasher body 10 and a front door 12, which is tiltably hinged to the dishwasher body 10, so as to be tiltable about a generally horizontal axis A. The dishwasher is of the built-in type and thus can be integrated into an existing kitchen design by fixing a respective decor panel 14, for example, a wooden panel, to the dishwasher door 12. To this end, the dishwasher door 12 is provided with means (not shown in the FIGURE) for fixing decor panel 14, such as, for example, a plurality of slots or grooves into which hooks engage which are mounted to the rear side of decor panel 14. When a dishwasher as shown in the drawing is delivered from the manufacturer to a retailer, the dishwasher is installed at the retailer without any decor panel 14, which usually is attached when the dishwasher has been sold to a customer and is installed at its end use position. In dependency of the material and design, decor panels for dishwashers may have a considerable weight of up to about 12 kg, which thus considerably adds to the weight of the bare dishwasher door 12.

In order to, on the one hand, balance the weight of the door in several intermediate positions between the fully open position and the closed position and, on the other hand, in order to exert a closing force onto the door at least in the last part of the door movement towards the closed position, the dishwasher is equipped with a door-balancing system, which in the drawing generally is designated with 16. In the embodiment shown in the drawing, door-balancing system 16 comprises a lever 18, which is pivotably fixed with respect to the dishwasher body 10. A first lever arm of lever 18 is linked to the dishwasher door 12, for example to a plate 28 of the door hinge, and a second lever arm of lever 18 is linked to a force-transmitting member 20, which is guided along generally vertical guiding surfaces 22, so as to move downwards when the dishwasher door 12 is opened and to move upwards when the door is closed. By designing the door-balancing system 16 such that a predetermined amount of friction is created between force-transmitting member 20 and guiding surfaces 22 when force-transmitting member 20 slides along guiding surfaces 22 when dishwasher door 12 is opened and closed, there is provided for a certain amount of balancing force to maintain the dishwasher door 12 also in intermediate positions between the fully opened and the completely closed positions.

A spring element 24, in the embodiment shown a tension spring, is attached to the upper end of force-transmitting member 20 so as to generate an increasing return or biasing force when the dishwasher door 12 is opened. In order to provide for a dampening of the door when the door is closed, a dampening element 26, preferably a hydraulic or pneumatic dampening element such as a pneumatic spring is attached to the force-transmitting member 20 in parallel to spring element 24.

In contrast to prior art appliances, in which the door closure dampening means, if present at all, was adapted to dampen the closing of the door in the decorated state, i.e. in a state where due to the higher weight of the door which for closing the door needs to be lifted the door is closed at a relatively low speed and hence does not require much dampening, in the dishwasher suggested herein the dampening element 26 is adjusted for dampening the closing of the door in its undecorated state, i.e. for the weight of the bare door 12 without decor panel 14.

It is to be understood that the present invention, of course, is not restricted to the embodiment shown in the drawing and, in particular is not restricted to embodiments with a door biasing means as shown, wherein the spring 24 and the damping member 26 are arranged vertically and in parallel. Thus, for example, a similar arrangement as shown could be used, wherein the force-transmitting member 20 is movable not in the vertical direction, but at an angle or in the horizontal direction, in which case also the spring element 24 and the dampening member 26 would be oriented correspondingly. Furthermore, instead of a parallel arrangement of spring member 24 and dampening element 26, also a serial arrangement of spring 24 and dampening element 26 could be used.

As noted above, the dampening element 26 also could be designed as a unit which operates independently from the door-balancing system.

Finally, the dampening means could be designed to comprise a first dampening element, which, be it already during manufacture or when installing the dishwasher, is adapted for dampening the closing of the door in the decorated state of the door, i.e. when a decor panel is attached to a door, as well as a second dampening element, which is or can be adapted to compensate any higher door-closing forces, that are caused by the lower weight of the door in its undecorated state. In such embodiments means may be provided for deactivating the said second dampening element after a decor panel was mounted to the door, so as to adjust the dampening means to its end use, i.e. to the weight of the door in its decorated state after final installation of the dishwasher. Such an embodiment could be implemented, for example, by providing two dampening elements, such as two pneumatic springs, in series, and providing means for blocking one of the two dampening elements. By selecting appropriate dampening characteristics of the two dampening elements, such as providing for a first harder damper and a second softer damper, one thus could easily select varying dampening characteristics for the different situations of use of the dishwasher.

1. Dishwasher of the built-in type comprising a door (12) which is tiltable about a generally horizontal axis (A), the door comprising means for fixing a decor panel (14), said dishwasher further comprising means (24) for biasing the door (12) towards the closed position and dampening means (26) for dampening the closing of the door, characterized in that said dampening means (26) is or can be adapted for dampening the closing of the door (12) in the undecorated state of the door

2. The dishwasher of claim 1, characterized in that said dampening means (26) comprises a hydraulic or pneumatic dampening element.

3. The dishwasher of claim 2, characterized in that said dampening means (26) comprises a pneumatic spring.

4. The dishwasher of claim 2, characterized in that said dampening means (26) comprises a shock absorber.

5. The dishwasher of claim 1, characterized in that said dampening means (26) is or can be adapted to dampen the closing of the door (12) in an angular range of 10° to 0°, preferably of 15° to 0° of the opening angle of the door with respect to the dishwasher body (10).

6. The dishwasher of claim 1, characterized in that said means (24) for biasing the door (12) towards the closed position is adjusted based on the weight of the door in the decorated state.

7. The dishwasher of claim 1, characterized in that said means (24) for biasing the door (12) towards the closed position comprises a spring arrangement (24).

8. The dishwasher of claim 1, characterized in that said dishwasher comprises a door balancing system (16) for balancing the door (12) in a plurality of intermediate positions between the opened and the closed positions of the door, and that said dampening means (26) is coupled to said door balancing system.

9. The dishwasher of claim 8, characterized in that said door balancing system (16) comprises a friction arrangement (20, 22) for exerting a predetermined friction in dependency of the position of the door (12).

10. The dishwasher of claim 8, characterized in that said means (24) for biasing the door (12) towards the closed position is coupled to said door balancing system (16).

11. The dishwasher of claim 1, characterized in that said dampening means (26) is suitably adapted for dampening the closing of the door (12) also in the decorated state of the door.

12. The dishwasher of claim 1, characterized in that said dampening means comprises a first dampening element which is or can be adapted for dampening the closing of the door in the decorated state of the door and a second dampening element which is or can be adapted to compensate any higher door closing forces caused by the lower weight of the door in its undecorated state.

13. The dishwasher of claim 12, characterized by means for deactivating said second dampening element after a decor panel was mounted to the door.
